(19) United States
(12) Patent Application Publication
(10) Pub. No.: US 2004/0208007 A1
(43) Pub. Date: Oct. 21, 2004

(54) Colored light bulb for a display device

(76) Inventor: Brian K. Munari, Waterford, MI (US)

Correspondence Address: Brian K Munari, P,O, BOX 7637, SURPRISE, AZ, 85374, US

(21) Appl. No.: 10/418,618

(22) Filed: Apr. 21, 2003

(51) Int. Cl. F21V 9/08

(52) U.S. Cl. 362/293

(57) ABSTRACT

A colored light bulb (41) for use in a display device (13) for the purpose of producing new and unique lighting effects.

### FEDERALLY SPONSORED RESEARCH

Not applicable

### SEQUENCE LISTING OR PROGRAM

Not applicable

### BACKGROUND—FIELD OF INVENTION

This invention relates to light bulbs, specifically to colored light bulbs for use in a lava lamp display device for decorative lighting effects.

### BACKGROUND—DISCUSSION OF PRIOR ART

Display devices of the type commonly referred to as lava lamps are well known in the art. An example of one such device is described in U.S. Pat. No. 3,387,396 to Smith and in U.S. Pat. No. 3,570,156 to Walker. Such display devices typically comprise a container which holds a solid and liquid substance. A heating element situated at the bottom of the container heats the solid substance causing the same to liquefy and flow. The heating element is typically in the form of a light bulb so the container and its contents can be illuminated.

The lava lamp display device in its most common form uses an appliance size incandescent light bulb. Manufactures refer to an appliance size light bulb as a 40 Watt type A15. This type of light bulb produces white light and has a clear or frosted finish. Light bulbs larger than type A15 will not fit into the base of the lava lamp display device. Smaller light bulbs may fit but do not provide the heat energy required for the lava lamp display device to operate properly.

Lava lamp display devices are available in a variety of colors. Consumers can choose the color of the solid substance and the color of the liquid substance inside the container. In addition, consumers can choose the color of the base structure which holds the container. If a consumer tires of the lava lamp display device, they may wish to change how it looks. The consumer can replace the container with one that has a different color liquid, solid or both. They can also replace the base structure with one of a different color or design. The cost of these components is relatively high when compared with the cost of a replacement light bulb. However, type A15 light bulbs are only available in frosted or clear and produce white light. Therefore, consumers cannot change the look of their lava lamp display device by simply replacing the light bulb.

Over the years no significant changes have been made to the appliance size light bulb to improve the overall visual effect when used in a lava lamp display device. Other heating and illuminating elements have been created which produce unique lighting effects. However, these elements were not designed for use in a lava lamp display device and therefore have the following limitations:

They do not fit in a lava lamp display device

They do not provide the proper amount of heat energy

They do not provide the proper illumination

Typical of such heating and illuminating elements are those shown in the following United States patents:

| | | | |
|---|---|---|---|
| D443,703 | Sood | 1,798,745 | Lyman |
| D188,214 | Atkin | D379,550 | Kuo |
| 664,222 | Krumwiede | 5,749,646 | Brittell |
| 4,366,407 | Walsh | 3,312,814 | Reading |

The Sood patent discloses an ornamental design for a light bulb with rings near the top. The Lyman patent describes patterns of reflective surfaces on a light bulb to maximize the effective light rays and to avoid dark spots. The Atkin patent illustrates a lamp holder and lens which can be used to change the effective color of a light source. The Kuo patent sets forth a decorative diffuser globe for enclosing a light bulb. The Krumwiede patent reveals a cover or shade for incandescent lamps to alter their appearance and color. The Brittell patent is directed towards a special effects lamp which is capable of emitting different colors of light at different times by using multiple light sources from within a single bulb. The Walsh patent discloses an incandescent lamp with a transparent heat mirror coating to produce a desired color and to reflect thermal radiation back to the filament. The Reading patent describes a detachable color filter for light bulbs in electric sign art.

Furthermore, it is understood that colored light bulbs have been available for many years. However, a colored version of the appliance size light bulb is not available, especially for use in a lava lamp display device.

### BACKGROUND—OBJECTS AND ADVANTAGES

Accordingly, it is the main object of the present invention to provide an improved light bulb for use in a lava lamp display device. The improved light bulb will produce new and unique lighting effects when used in a lava lamp display device. Further objects and advantages will become clear from a consideration of the drawings and ensuing descriptions.

The primary embodiment of the present invention is a colored light bulb for use in a lava lamp display device whereby said colored light bulb will produce new and unique lighting effects.

### DRAWINGS—FIGURES

FIG. 1 shows an appliance size light bulb with a colored coating

FIG. 2 shows a colored light bulb in a lava lamp display device

FIG. 3 shows one version of a multicolored appliance size light bulb

FIG. 4 shows another version of a multicolored appliance size light bulb

FIG. 5 shows an appliance size light bulb with a partial color coating

FIG. 6 shows the use of a color filter in a lava lamp display device

FIG. 7 shows an alternative heating and illuminating element for a lava lamp display device

### DRAWINGS—REFERENCE NUMERALS 13 display device 33 color filter 19 light bulb 36 heating element 22 light emitting diodes 41 colored light bulb 27 colored regions 45 colored coating

### DETAILED DESCRIPTION

Description of the Preferred Embodiment

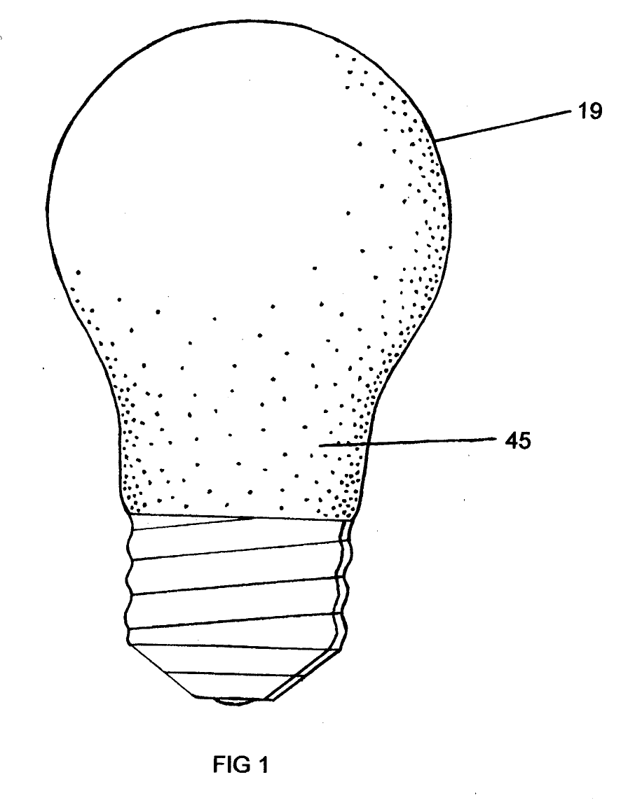

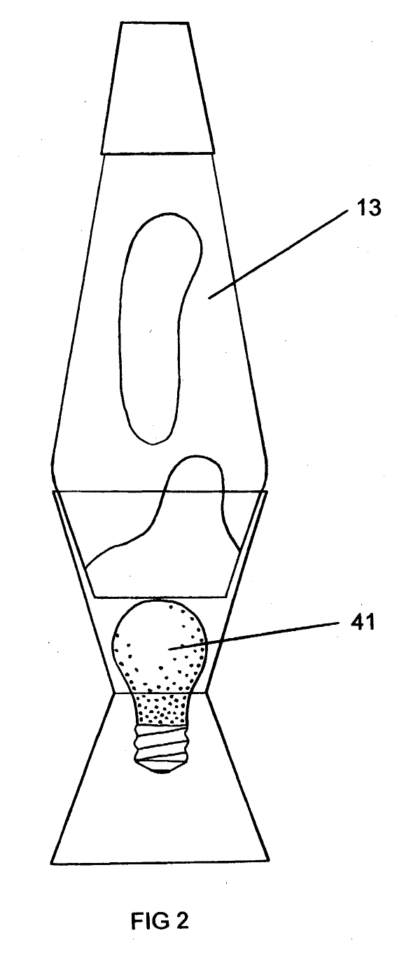

FIG. 1 shows a prospective view of the present invention. It comprises a 40 Watt type A15 appliance size light bulb 19 which has a colored coating 45. FIG. 2 shows a colored light bulb 41 in a lave lamp display device 13.

Operation of the Preferred Embodiment

When the colored light bulb in FIG. 2 is powered from an external power source (not shown) it will radiate both heat and colored light. The heat allows the display device to operate properly. The colored light will produce new and unique lighting effects.

Description of Additional Embodiments

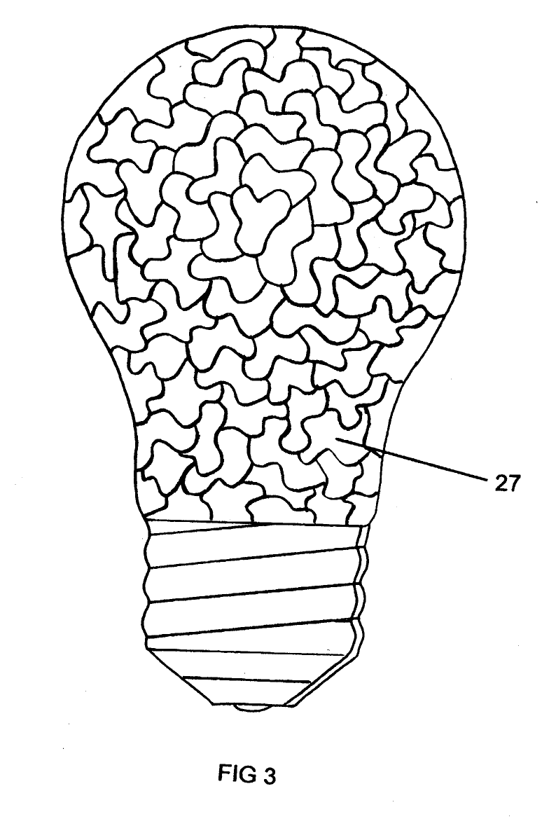

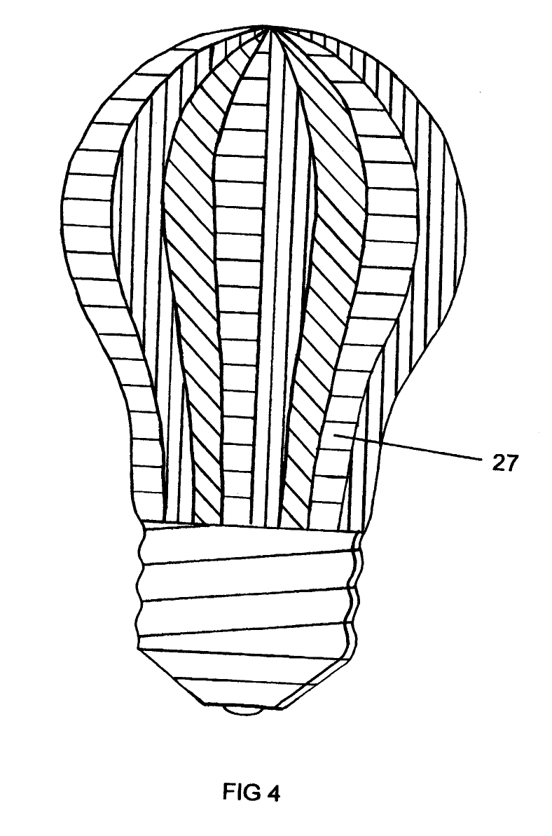

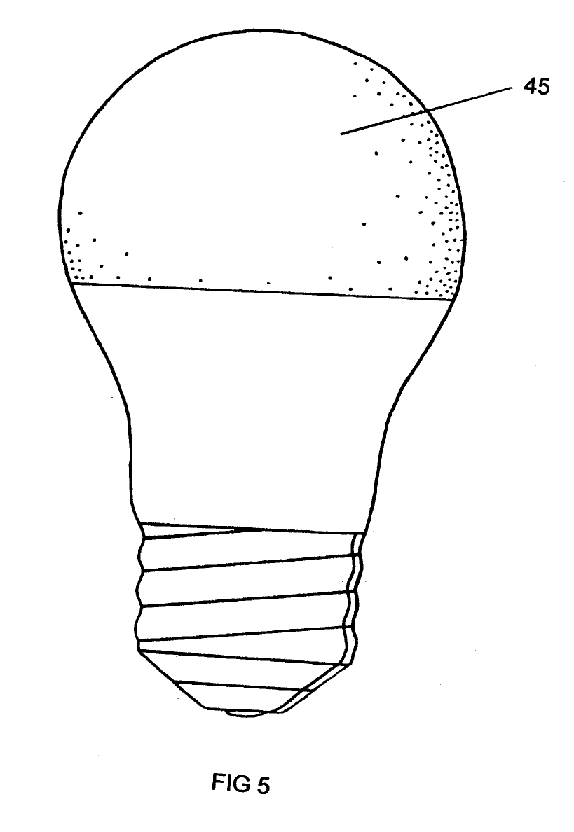

Additional embodiments of the invention are shown in FIGS. 3, 4 and 5. FIGS. 3 and 4 show the light bulb with different colored regions 27 in different patterns. FIG. 5 shows the light bulb with the colored coating only on the top part of the bulb.

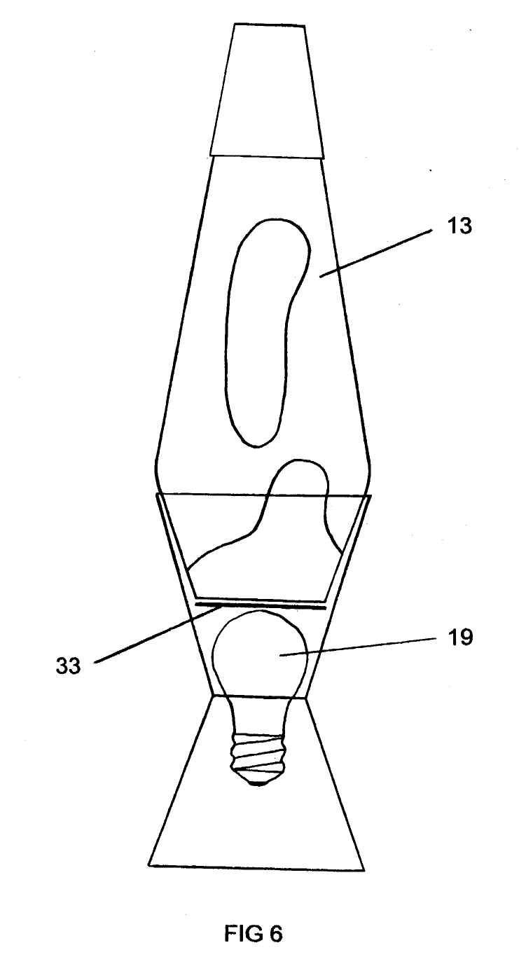

A further embodiment of the invention is shown in FIG. 6. A color filter 33 can be placed between the light source and the display device container to produce new and unique lighting effects similar to that of the colored light bulb.

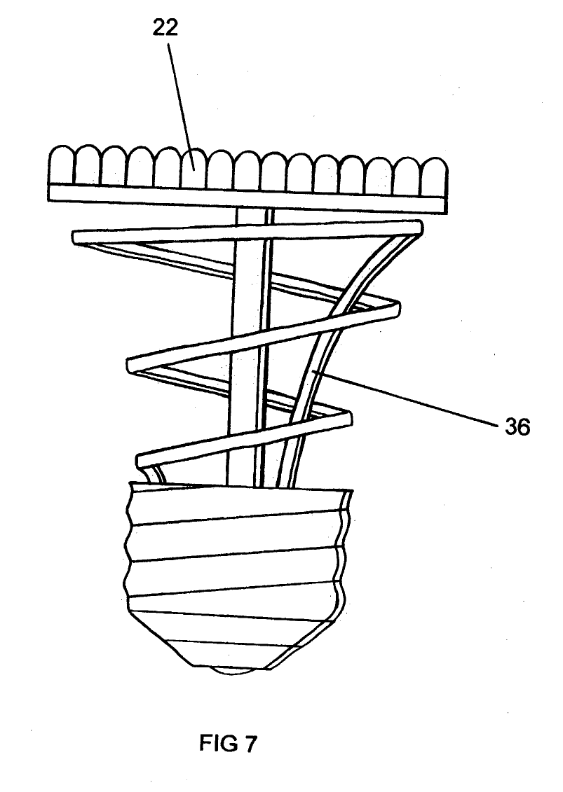

A still further embodiment of the invention is shown in FIG. 7. It comprises a heating element 36 and a light source such as an array of light emitting diodes 22.

Operation of Additional Embodiments

In FIGS. 3 and 4 the light bulb has different colored regions which will produce new and unique lighting effects when used in the lava lamp display device. These lighting effects vary from that of a light bulb which emits only one color.

In FIG. 5 the colored light bulb has the colored coating on the top part of the bulb only. The lava lamp display device in its most common form is only exposed to light from the top of the bulb. Therefore, it is not necessary to have the colored coating on the entire bulb to achieve the same new and unique lighting effect.

In FIG. 6 the color filter can be of any shape, size, color, or multi-colored. The color filter can be placed in an appropriate position in the display device to effectively change the color of a light source. This will produce new and unique lighting effects similar to that of the colored light bulb.

In FIG. 7 the heating element and light emitting diodes simulate the effect of an incandescent light bulb. The heating element allows the lava lamp display device to operate properly and the light emitting diodes provide illumination. The light emitting diodes can be of any color or multi-colored.

It shall be understood the above descriptions and drawings are not intended to limit the scope of the present invention. Any variation and derivation common to those skilled in the art from the above description and drawings should be included in the scope of the invention.

### CONCLUSION, RAMIFICATION, AND SCOPE

Thus the reader shall see the preferred embodiment of the present invention provides an improved light bulb for use in a lava lamp display device which will create new and unique lighting effects.

While the above description contains many specificities, these should not be construed as limitations on the scope of the invention, but rather as an exemplification of several embodiments thereof. Other variations are possible such as a heating element without a light source for non-illuminated operation of the display device, computer controlled arrays of light emitting diodes which change color over time, or colorization of the reflective walls of the display device near the light source to produce a partial colorization of the light shining up into the display device.

Accordingly, the scope of the invention shall not be determined by the described embodiments, but by the appended claims and their legal equivalents.

I claim:

1. A colored light bulb for use in a lava lamp display device whereby said colored light bulb will produce new and unique lighting effects.

2. A method for producing colored light and heat for the proper operation of a lava lamp display device whereby said method will produce new and unique lighting effects.
